(19) United States
(12) Patent Application Publication
(10) Pub. No.: US 2009/0169187 A1
(43) Pub. Date: Jul. 2, 2009

(54) Information Recording/Reproducing Apparatus and Information Recording Method

(75) Inventors: Norihide KOHMOTO, Kawasaki (JP); Akinobu Watanabe, Kawasaki (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 12/343,610

(22) Filed: Dec. 24, 2008

(30) Foreign Application Priority Data
Dec. 28, 2007 (JP) 2007-339453

(51) Int. Cl. H04N 5/00; G11B 7/00

(52) U.S. Cl. 386/126; 369/275.3; 386/E05.001

(57) ABSTRACT

A seek time is shortened even when AV streams and non-AV streams are read continuously and alternately. When no space is available when a non-AV stream is recorded to a non-AV stream area, the non-AV stream area is closed, a non-use area is then split from the AV stream area to generate a recorded AV stream area and an intermediate state area and the AV stream area is closed. The intermediate state area is split and a new MD area and a new AV stream area are generated.

The present application claims priority from Japanese application JP2007-339453 filed on Dec. 28, 2007, the content of which is hereby incorporated by reference into this application.

### BACKGROUND OF THE INVENTION

1. Field of the Invention

This invention relates to an information recording/reproducing apparatus and an information recording method. More particularly, the invention relates to an information recording/reproducing apparatus that records information to a write-once type recording medium and reproduces the information recorded to the write-once type recording medium.

2. Description of the Related Art

UDF (Universal Disk Format) is known as a file format of an optical disk typified by DVD (Digital Versatile Disk) and UDF2.5 has been proposed at present. The file system based on this UDF2.5 has its characterizing features in duplexing of file management information and concentrated arrangement of the file management information. Here, the term “file management information” represents information that indicates which file exists at which position of a recording medium and is updated when a file is written to the recording medium or when the file is erased from the recording medium, on the contrary. The term “duplexing of the file management information” means a recording operation that records the same file management information to two positions spaced apart from each other on the recording medium (on the inner circumferential side and the outer circumferential side of a disk, for example). Even when the management information recorded at one of the positions cannot be read out due to scratch or degradation of the recording medium, the file management information at the other can be read out. Consequently, it is possible to prevent the problem that the file recorded to the recording medium cannot be read out because the file management information cannot be read out. The term “concentrated arrangement of the file management information” means a continuous recording operation of one file management information to the recording medium without dispersing it. Because the concentrated arrangement makes it possible to rapidly read out the file management information, the time necessary for reading out the recorded file can be shortened.

JP-A-2006-127700 discloses a method that employs the concentrated arrangement of areas for the file management information and other information on a recording medium based on the UDF2.5 and allocates a different area when such areas become full. The file format in accordance with the UDF2.5 is directed to rewritable type recording media such as BD-RE (Blu-ray Disc Rewritable). Therefore, this patent document does not take overwrite of data to write-once type recording media such as BD-R (Blu-ray Disc Recordable) into consideration. Therefore, the patent document accomplishes overwrite of data to the write-once type recording media by recording update data to another area called “ISA/OSA”.

On the other hand, a file format relying on UDF2.6 and directed to write-once type recording media such as BD-R has been proposed recently. When file management information (Meta Data; hereinafter called “MD”) is updated with write-once of user data in the same way as in the rewritable type recording media based on the UDF2.5 in the write-once type recording media based on this UDF2.6, MD is recorded to the file management information area (hereinafter called “MD area”). To duplex the file management information, Metadata Mirror information (hereinafter called “MDM”) as backup of this MD is recorded also to the MDM area.

Since information cannot be rewritten in the write-once type recording media, a Pseudo Over-Write (hereinafter called “POW”) system is employed. When a recording instruction is given from a host, etc, to again record information to the recorded area to which recording is already made in the write-once type recording media, a drive device of the POW system automatically writes the information to an SRR (Sequential Recording Range) area for rewriting to generate the state as if the information were over-written to the recorded area. Pseudo overwrite is executed when MD is newly recorded to the MD area after MD is once recorded to the MD area. When the area to which MD is once recorded is a leading area positioned at the leading position of the MD area, for example, new MD is recorded to an area next to the leading area. Recording of information to a non-recorded area in place of the recorded area is called “alternate recording”. Information representing that alternate recording is made to the area next to the leading area is recorded to an area called “Defect List management area” that is different from the MD area. Consequently, it is possible to establish the state as if MD were overwritten to the leading area of the MD area in the write-once type recording media. As for MDM, too, it is possible to establish the state as if information were overwritten to the MDM area in the write-once type recording media by executing pseudo over-write in the MDM area and recording the link information in the Defect List management area in the same way as in MD.

JP-A-2005-353243 and JP-A-2005-004952 disclose a technology for recording management information to a part of a user data area when the residual quantity of the management information area (MD area) as a non-user data area becomes small.

### SUMMARY OF THE INVENTION

The technologies disclosed in JP-A-2006-127700, JP-A-2005-353243 and JP-A-2005-004952 described above record all the user data to one file recording area. Therefore, a non-AV stream (non-audio-video information) such as a CLIP file and a PLAYLIST file and an AV stream (audio-video information) are recorded in mixture to the same recording area, for example. When the AV stream and the non-AV stream are read continuously and alternately, for example, the seek time increases drastically.

With the background described above, the invention proposes an information recording/reproducing apparatus and an information recording method that can shorten the seek time even when audio-video information and non-audio-video information are read continuously and alternately.

To accomplish the object described above, the invention provides an information recording/reproducing apparatus for recording information to a write-once type information recording medium and reproducing the information recorded to the write-once type information recording medium, comprising an area generation unit for generating inside the write-once type recording medium at least a management area for recording file management information for managing a data structure of user data, an audio-video area for recording audio-video information contained in the user data and a non-audio-video area for recording non-audio-video information contained in the user data; a first splitting unit for closing the management area or the non-audio-video area not capable of recording when a recording capacity of the management area or the non-audio-video area is insufficient and the file management information or the non-audio-video information cannot be recorded additionally, splitting the audio-video area into a recorded area and a non-use area and closing the audio-video area split as the recorded area; a second splitting unit for splitting the non-use area split by the first splitting unit into a new management area or a new non-audio-video area and a new audio-video area; and a recording unit for additionally recording the file management information or the non-audio-video information to the new management area or the new non-audio-video area split by the second splitting unit.

The invention provides also an information recording method in an information recording/reproducing apparatus for recording information to a write-once type information recording medium and reproducing the information recorded to the write-once type information recording medium, comprising the area generation step of generating inside the write-once type recording medium at least a management area for recording file management information for managing a data structure of user data, an audio-video area for recording audio-video information contained in the user data and a non-audio-video area for recording non-audio-video information contained in the user data; the first splitting step of closing the management area or the non-audio-video area not capable of recording when a recording capacity of the management area or the non-audio-video area is insufficient and the file management information or the non-audio-video information cannot be recorded additionally, splitting the audio-video area into a recorded area and a non-use area and closing the audio-video area split as the recorded area; the second splitting step of splitting the non-use area split by the first splitting step into a new management area or a new non-audio-video area and a new audio-video area; and the recording step of additionally recording the file management information or the non-audio-video information to the new management area or the new non-audio-video area split by the second splitting unit.

The invention can shorten the seek time when audio-video information and non-audio-video information are read continuously and alternately, too.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing a structural example of a video camera according to an embodiment of the invention;

FIG. 2 is an explanatory view showing a format state of an optical disk before finalization;

FIG. 3 is an explanatory view showing a format state of the optical disk after finalization;

FIG. 4 is a flowchart showing the flow of processing when one scene is recorded;

FIG. 5 is a flowchart showing the flow of space judgment processing of a non-AV stream area;

FIGS. 6A-6C are an explanatory view schematically showing the transition state of a format change that is executed when no space exists in the space judgment processing of the non-AV stream area;

FIG. 7 is a flowchart showing the flow of the space judgment processing of an MD area;

FIGS. 8A-8C are an explanatory view schematically showing the transition state of the format change that is executed when no space exists in the space judgment processing of the MD area;

FIG. 9 is a flowchart showing the flow of a write processing of POW;

FIG. 10 is an explanatory view schematically showing the state of a write processing that is executed when a space exists in an SRR area of a writing source sector of POW in the write processing of POW;

FIG. 11 is an explanatory view schematically showing the state of the write processing that is executed when no space exists in the SRR area of the writing source sector of POW in the write processing of POW; and

FIG. 12 is an explanatory view showing a format state of an optical disk after finalization.

### DETAILED DESCRIPTION OF THE EMBODIMENTS

An information recording/reproducing apparatus and an information recording method according to a preferred embodiment of the invention will be hereinafter explained in detail with reference to the accompanying drawings.

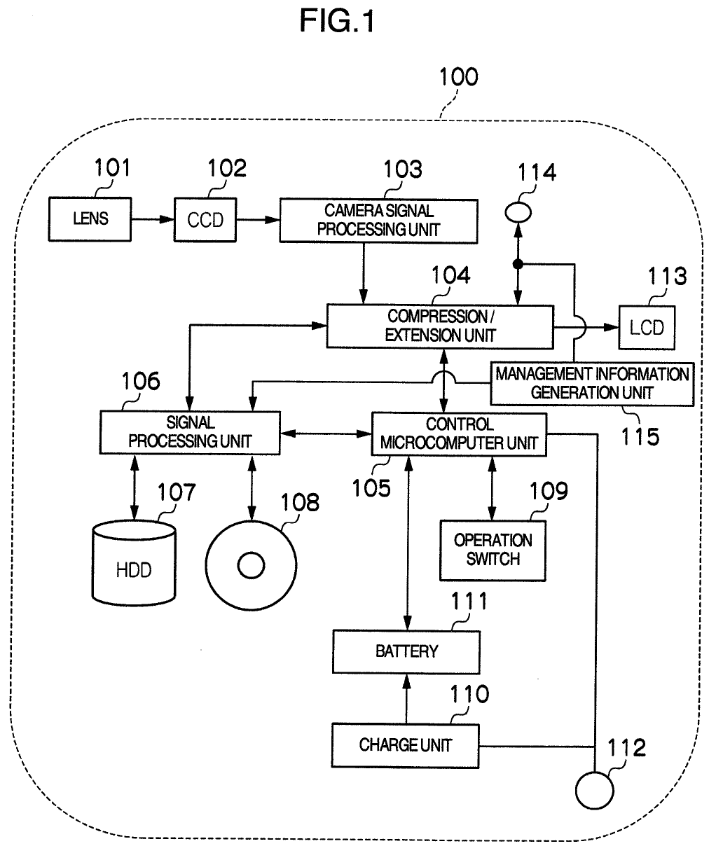

First of all, a construction of a video camera as an example of an information recording/reproducing apparatus according to the invention will be explained with reference to FIG. 1. FIG. 1 is a structural view of the video camera in the embodiment of the invention. As shown in the drawing, the video camera 100 includes a lens 101, an imaging sensor 102 (CCD), a camera signal processing unit 103, a compression/extension unit 104, a control micro-computer unit 105, a signal processing unit 106 (area generation unit, first splitting unit, second splitting unit, recording unit, backup unit), a hard disk drive 107 (HDD), disk media 108, an operation switch 109, a charge unit 110, a battery 111, an external power source input unit 112, a liquid crystal display 113 (LCD), an external input/output terminal 114 (I/F) and a management information generation unit 115. BD (Blu-ray Disk) and DVD correspond to the disk media 108, for example. Various functions of the video camera will be explained dividedly about the constituent members described above for the sake of convenience of explanation but these functions may well be assembled into one or a plurality of chips in accordance with circuit design.

The operations among the constituent members of the video camera 100 shown in FIG. 1 will be explained. The image of a subject is taken by the CCD 102 through the lens 101 and is converted to electric signals. The camera signal processing unit 103 converts the electric signals converted by the CCD 102 to image signals.

The compression/extension unit 104 converts the image signal converted by the camera signal processing unit 103 to a digital image signal under control of the control micro-computer unit 105. The compression/extension unit 104 converts an external input image signal to the digital image signal when the input is switched to the external input/output terminal 114.

The signal processing unit 106 records the digital image signal converted by the compression/extension unit 104 into an external storage such as BD, DVD, HDD or the like. In consequence, the data is recorded to a write-once type recording medium such as a BD-R (Blu-ray Risk Recordable) formatted by UDF2.6, for example.

The management information generation unit 115 generates file management information when the file management information such as MD information or MDM information is updated by write-once of user data. The signal processing unit 106 records this file management information to the external storage such as BD, DVD, HDD, etc.

The control micro-computer unit 105 controls the signal processing unit 106 in accordance with the operation instruction from the operation switch 109. The signal processing unit 106 executes a dubbing processing between media by reading out the image signals recorded to BD or DVD and recording it to HDD or by reading out the image signals recorded to HDD and recording it to BD or DVD under control of the control micro-computer unit 105.

The compression/extension unit 104 extends the signal recorded to the external storage to the image signal and outputs it to the external input/output unit 114 or to the liquid crystal display 113. Incidentally, the display for displaying the image is not limited to the liquid crystal display but may be an organic EL display, for example.

The external power source input unit 112 inputs power supplied from outside such as an AC power source. The charge unit 110 charges the battery 111 by power supplied from the external power source input unit 112. In consequence, the apparatus can be operated by the external power source when the power source is supplied from the external power source input unit 112 and by the battery 111 when the power is not supplied from the external power source input unit 112. Incidentally, all the functions required for charging need not always be incorporated in the video camera 100 and a part or the whole of the functions necessary for charging may be provided outside the external power source input unit 112.

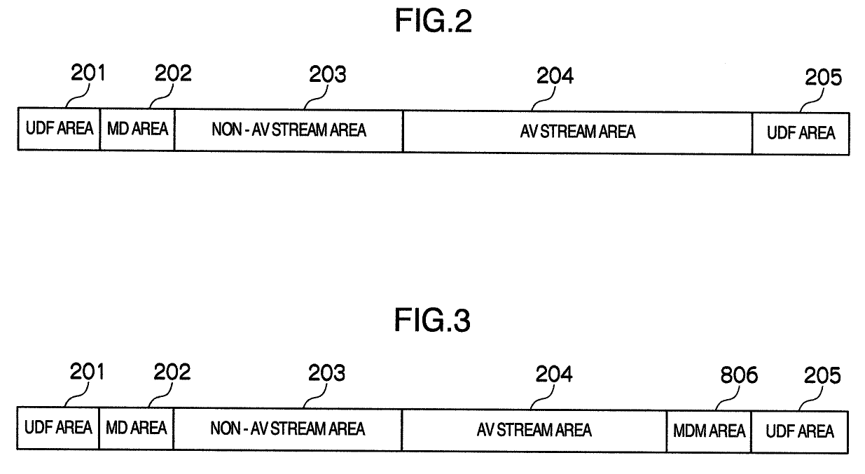

Next, the format state in an optical disk (write-once type recording medium) used in the video camera 100 such as BD-R will be explained with reference to FIGS. 2 and 3. FIG. 2 shows the format state of the optical disk before finalization. FIG. 3 shows the format state of the optical disk after finalization. In this embodiment, the processing that records MDM into an MDM area will be defined and used as “finalize” or “finalization”.

In the formats shown in FIGS. 2 and 3, the inner circumference of the optical disk (address 0) is positioned at the extreme left and the outer circumference of the optical disk, at the extreme right. Data is serially arranged from the extreme left. As shown in FIG. 2, the optical disk before finalization has, as an SRR area, a UDF area 201, an MD area 202 (management area), a non-AV stream (non-Audio Video Stream) area 203, an AV stream (Audio Video Stream) area 204 and a UDF area 205, for example.

A UDF file for managing a volume structure of the disk by UDF is recorded to the UDF area 201. The term “volume structure” represents which information is recorded to which area as the UDF format. A backup file of the UDF file recorded to the UDF area 201 is copied to the UDF area 205.

MD is recorded to the MD area 202. MD is file management information that is recorded in accordance with a processing such as recording and edition of a scene. It is the information for managing the file structure of the user data such as a directory structure of the user data.

Entity data of the non-AV stream file (non-Audio Video information) such as a CLIP file or a PLAYLIST file among the user data is recorded to the non-AV stream area 203. Entity data of the AV stream file (Audio Video information), for example, among the user data is recorded to the AV stream area 204. Incidentally, the AV stream includes not only the video and audio contents but also character strings, static images and those other contents for which the real time property of the submission time is of importance such as captions and logos. A Defect List management area is arranged on the inner circumferential side with respect to the UDF area 201 but is omitted from illustration in this embodiment for the sake of convenience of explanation.

As shown in FIG. 3, the optical disk after finalization is different from the optical disk before finalization in that it has the MDM area 806 in addition to each SRR area the optical disk before finalization has. Metadata Mirror information for backing up the MD is recorded to the MDM area 806.

The video camera 100 according to this embodiment is an information recording/reproducing apparatus that records and reproduces various kinds of information by using the recording media that conform with UDF2.6. A necessary area is allocated from the AV stream area 204 when the MD area 202 or the non-AV stream area 203 gets into saturation.

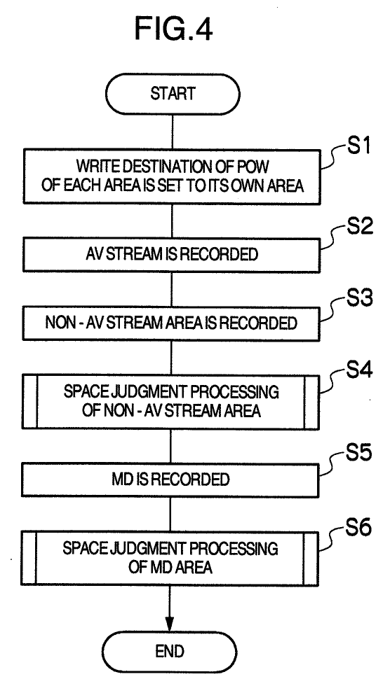

Next, the flow of processing for recording one scene by using the video camera 100 of this embodiment will be explained with reference to FIG. 4.

FIG. 4 is a flowchart showing the flow of processing when one scene is recorded. The term “one scene” hereby used means the scene that is recorded during the period from push-down of a recording button of the video camera 100 to push-down of a recording stop button.

First of all, the signal processing unit 106 sets the write destination of POW in the MD area, the non-AV stream area and the AV stream area to the MD area 202, the non-AV stream 203 and the AV stream area 204 of its own areas, respectively (step Si). Incidentally, the write processing of POW will be described later.

Next, the signal processing unit 106 records the AV stream to the AV stream area 204 (step S2). The signal processing unit 106 then records the non-AV stream such as the CLIP file to the non-AV stream area 203 (step S3) and executes the space judgment processing of the non-AV stream area (step S4). This space judgment processing of the non-AV stream area will be described later.

The signal processing unit 106 subsequently records MD to the MD area 202 (step S5) and executes the space judgment processing of the MD area (step S6). This space judgment processing of the non-AV stream area will be described later.

Incidentally, to edit one scene, the processing exclusive of the step S2 from each step shown in FIG. 4 is executed.

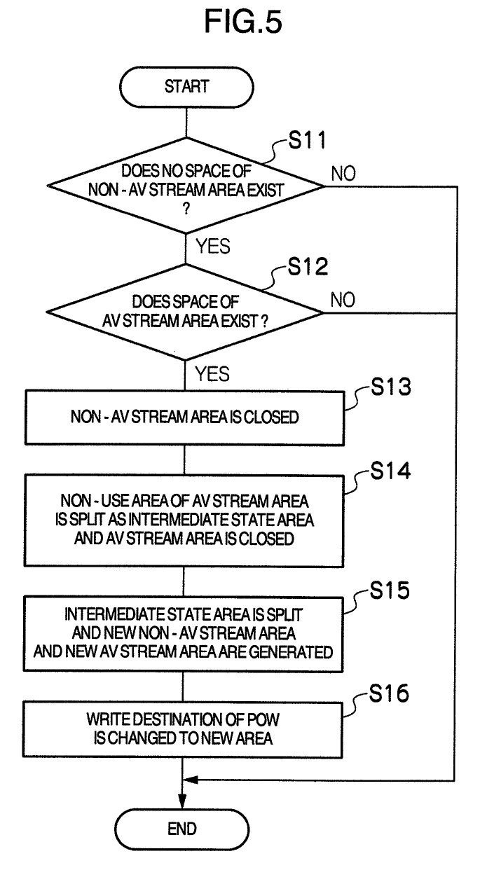

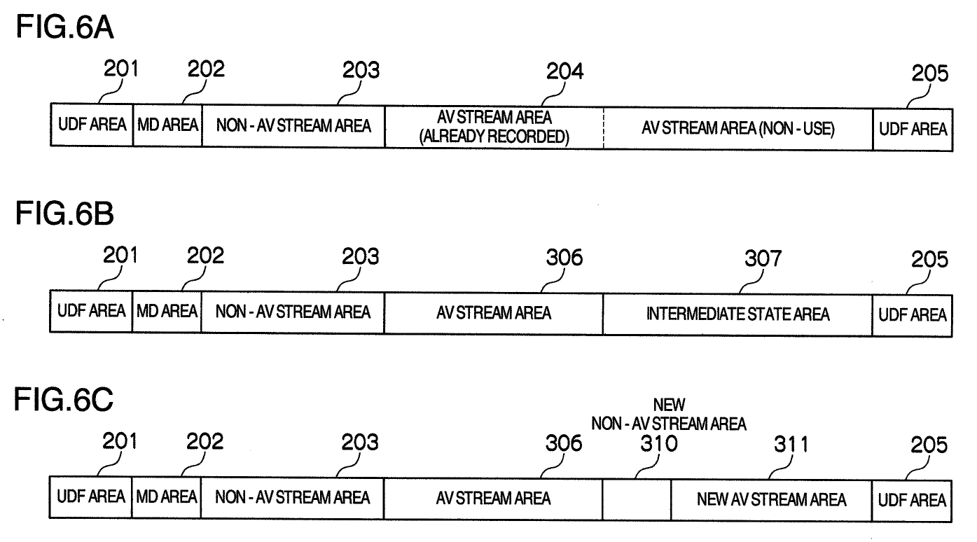

The space judgment processing of the non-AV stream area described above will be explained with reference to FIGS. 5 and 6. FIG. 5 is a flowchart showing the flow of the space judgment processing of the non-AV stream area and FIG. 6 schematically shows the transition state of the format change that is executed when no space exists in the space judgment processing of the non-AV stream area.

First of all, the signal processing unit 106 judges whether or not no space exists in the non-AV stream area 203 (step S11). When this judgment proves NO (step S11: NO), the space judgment processing of the non-AV stream area is finished.

When no space is judged as existing in the non-AV stream area 203 in the judgment of the step S11 (step S11: YES), on the other hand, the signal processing unit 106 judges whether or not a space area for newly generating a non-AV stream area exists in the AV stream area 204 (step S12). When this judgment proves NO (step S12: NO), the space judgment processing of the non-AV stream area is finished.

When the space area is judged as existing in the AV stream area 204 in the judgment of the step S12 (step S12: YES), on the other hand, the signal processing unit 106 closes the non-AV stream area (step S13).

Subsequently, the signal processing unit 106 splits a non-use area from the AV stream area 204 shown in FIG. 6A, generates a recorded AV stream area 306 and an intermediate state area 307 and closes the AV stream area 306 shown in FIG. 6B (step S14). A Reserve Track command or a Split command defined by the ATAPI standard can be used as the method of splitting the area.

The signal processing unit 106 then splits the intermediate state area 307 shown in FIG. 6B and generates a new non-AV stream area 310 and a new AV stream area 311 shown in FIG. 6C (step S15).

The signal processing unit 106 changes the write destination of POW in the non-AV stream area and the AV stream area to the new non-AV stream area 310 and the new AV stream area 311, respectively (step S16).

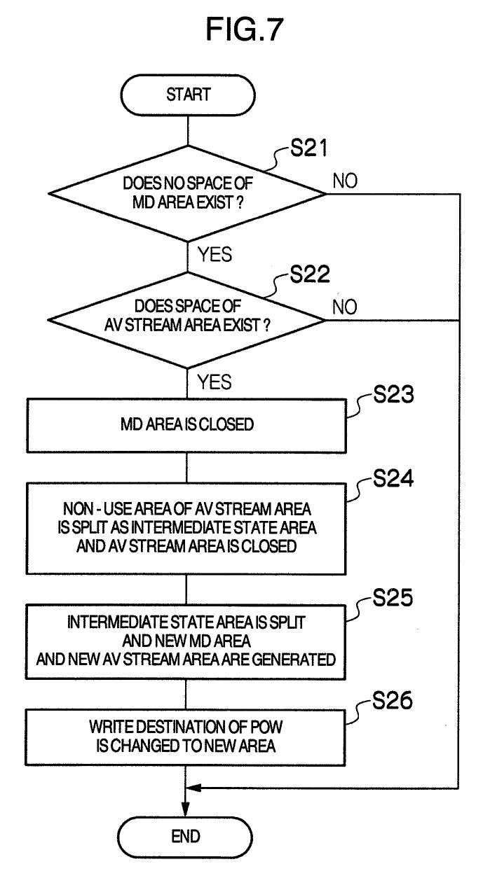

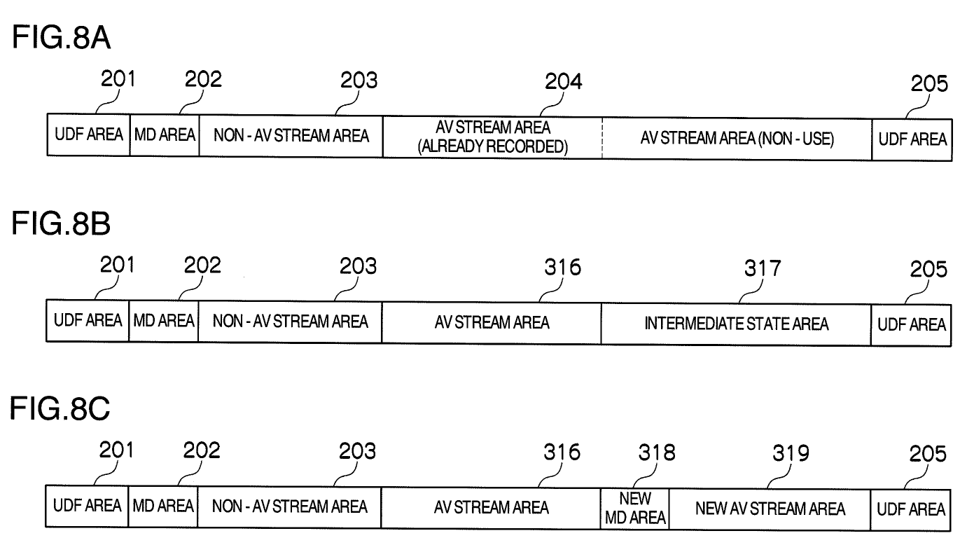

Next, the space judgment processing of the MD area described above will be explained with reference to FIGS. 7 and 8. FIG. 7 is a flowchart showing the flow of the space judgment processing of the MD area and FIG. 8 schematically shows the transition state of the format change that is executed when no space exists in the space judgment processing of the MD area.

The signal processing unit 106 first judges whether or not no space exists in the MD area 202 (step S21). When this judgment proves NO (step S21: NO), the space judgment processing of the MD area is finished.

When no space is judged as existing in the MD area 202 in the judgment of the step S21 (step S21: YES), on the other hand, the signal processing unit 106 judges whether or not a space area for newly generating an MD area exists in the AV stream area 204 (step S22). When this judgment proves NO (step S22: NO), the space judgment processing of the MD area is finished.

When the space area is judged as existing in the AV stream area 204 in the judgment of the step S22 (step S22: YES), on the other hand, the signal processing unit 106 closes the non-AV stream area (step S23).

Subsequently, the signal processing unit 106 splits a non-use area from the AV stream area 204 shown in FIG. 8A, generates a recorded AV stream area 316 and an intermediate state area 317 and closes the AV stream area 316 shown in FIG. 8B (step S24).

The signal processing unit 106 then splits the intermediate state area 317 shown in FIG. 8B and generates a new MD area 318 and a new AV stream area 319 shown in FIG. 8C (step S25).

The signal processing unit 106 changes the write destination of POW in the MD area and the AV stream area to the new MD area 318 and the new AV stream area 319, respectively (step S26).

Next, the write processing of POW described above will be explained in detail. The write processing of POW is executed in the following way by the signal processing unit 106. When an overwrite update instruction for recording again the information to the sector to which the information has already been recorded is received, the update information is recorded to the SRR area as the write destination and alternate information containing the address of the writing source sector of POW as the sector to which the information has already been recorded and the address of the write destination sector of POW as the sector to which the update information is recorded in practice is recorded to a Defect List management area. Incidentally, the SRR area of the write destination may be the same as, or different from, the SRR area in which the writing source sector of POW exists.

When the space exists in the SRR area including the writing source sector of POW in this embodiment (non-saturation), the update information is written into the SRR area. When no space exists in the SRR area including the writing source sector of POW (saturation), the update information is written into a different SRR area that is newly allocated. In the processing of recording of one scene described above (refer to FIG. 4), the explanation has been given on the case where the SRR area inclusive of the writing source sector of POW is the MD area 202 and the non-AV stream area 204.

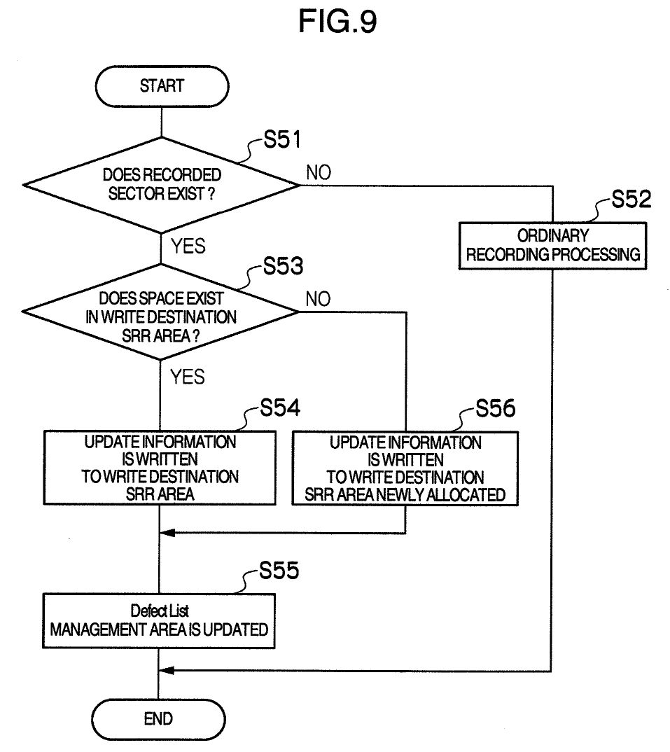

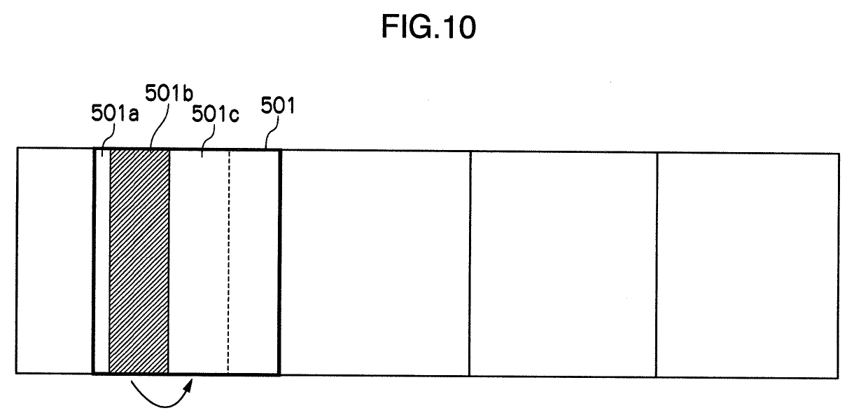

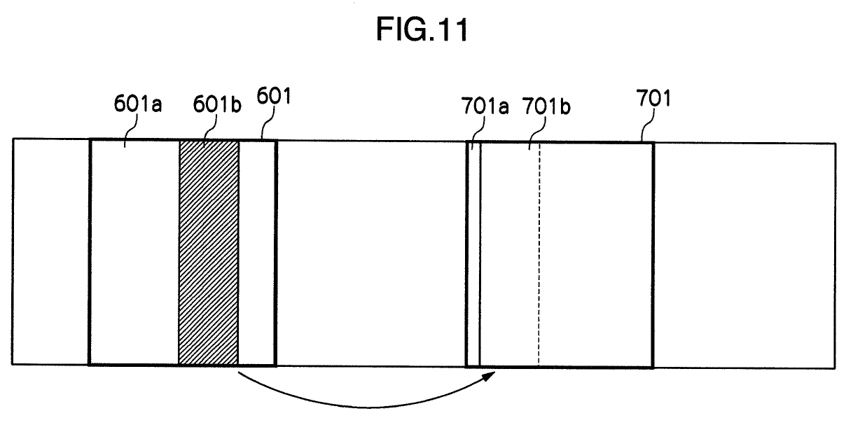

The write processing of POW will be explained with reference to FIGS. 9 to 11. FIG. 9 is a flowchart showing the flow of the write processing of POW. FIG. 10 is an explanatory view showing schematically the state of the write processing that is executed when a space exists in the SRR area of the writing source sector of POW in the write processing of POW. FIG. 11 is an explanatory view showing schematically the state of the write processing that is executed when no space exists in the SRR area of the writing source sector of POW in the write processing of POW.

First, when an instruction of recording information is given, the signal processing unit 106 judges whether or not the sector to which this information is to be recorded is the one that has already been recorded (step S51). When the judgment result proves NO (step S51: NO), the signal processing unit 106 executes an ordinary processing of writing once the information to the space area (step S52) and finishes the write processing of POW.

When the sector is judged as the recorded sector in the judgment of the step S51, that is, when the overwrite update instruction described above is received (step S51: YES), on the other hand, the signal processing unit 106 judges whether or not a space exists in the write destination SRR area of POW set (step S53).

When the space is judged as existing in the write destination SRR area of POW set by this judgment (step S53: YES), the signal processing unit 106 records the update information to the write destination SRR area of POW set (step S54) and also records the alternate information of the Defect List management area (step S55). Concrete explanation will be given hereby with reference to FIG. 10. The part from the start to an intermediate part of the SRR area is the recorded areas 501a and 501b in the write destination SRR area 501 of POW set and the rest are non-use areas. When overwrite update instruction of the information 501b to the SRR area 501 is given, whether or not a space for recording the update information of the information 501b exists in the SRR area 501 is first judged. When the space exists as shown in FIG. 10, the update information 501c is recorded to the space area capable of write-once and succeeding the recording area of the information 501b of the SRR area 501.

When the space is not judged as existing in the write destination SRR area of POW set in the judgment of the step S53 (step S53: NO), on the other hand, the signal processing unit 106 writes the update information to the write destination area of POW newly allocated(step S56) and also records the alternate information to the Defect List management area (step S55). Concrete explanation will be given hereby with reference to FIG. 11. The part from the start to an intermediate part of the write destination SRR area 601 of POW set is the recorded areas 601a and 601b and the rest are non-use areas. When overwrite update instruction of the information 601b to the SRR area 601 is given, whether or not a space for recording the update information of the information 601b exists in the SRR area 601 is first judged. When no space exists as shown in FIG. 11, the update information 701b is recorded to the space area succeeding the recording area of the information 701a of the SRR area 701 newly allocated.

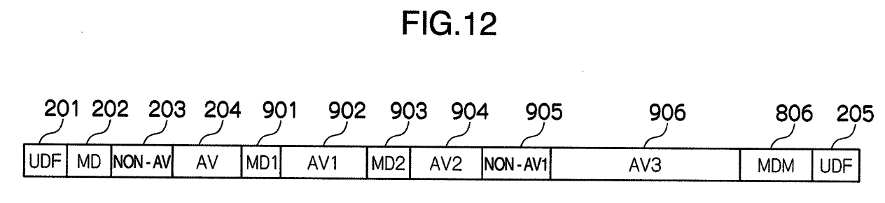

Next, the format state of the optical disk in which the MD area, the non-AV stream area and the AV area are dispersedly arranged will be explained with reference to FIG. 12. FIG. 12 shows the format state of the optical disk after finalization. Like reference numerals are used to identify like items as in FIG. 3 and the explanation of such items will be omitted.

The MD areas 901 and 903 are those MD areas which are split from the AV stream area 204 and are newly allocated. The non-AV stream area 905 is non-AV stream area which is split from the AV stream area 204 and are newly allocated. The AV stream areas 902, 904 and 906 are those AV stream areas which are split from the AV stream area 204 and are newly allocated.

The size of an MDM area 806 is equivalent to the size allocated to the MD areas 202, 901 and 903. More concretely, the size of the MDM area 806 is equal to the size of the MD area 202 when the MD area is only the MD area 202, for example. When the MD area 901 and the MD area 903 are further added as the MD area, a continuous area containing the last address of the latest AV stream area in the space area inside the latest AV stream area immediately before the latest AV stream area 806 is newly allocated to the MDM area 806 as the area for recording MD of the MD area 901 and the MD area 903. In other words, the MDM area 806 is extended and the latest AV stream area is reduced to the extent corresponding to the extension of the MDM area 806.

Whenever the MD area is allocated newly in the manner described above, the MDM area can be extended by using the space area of the AV stream area. Therefore, even when the MD areas are dispersedly allocated, the MDM area can be secured in match with the total size of the MD areas. For this reason, it is not necessary to secure in advance the MDM area as the space area before finalization and use efficiency of the allocated storage area can be improved.

As described above, when the optical disk such as BD-R is formatted, the video camera 100 according to the embodiment can generate the non-AV stream area for recording the entity data of the non-AV stream file such as the CLIP file and the PLAYLIST file as the recording area for recording the user data and the AV stream area for recording the entity data such as the AV stream file. Therefore, the video camera 100 can drastically shorten the seek time in comparison with the case where both kinds of data are recorded as a mixture to one recording area.

When various kinds of format changes are made, the SRR area that is not used can be closed. Therefore, the insufficient SRR area can be extended while the number of open SRR areas is limited.

Because each SRR area can be later extended, initial allocation of the recording areas to the MD area, the non-AV stream area and the MDM area can be limited to the necessary minimum and use efficiency of the allocated storage areas can be improved.

The foregoing explanation has been made about the video camera 100 having the construction shown in FIG. 1 but the invention is not particularly limited to the video camera 100 having such a construction and can be applied to information recording/reproducing apparatuses having various other constructions.

It should be further understood by those skilled in the art that although the foregoing description has been made on embodiments of the invention, the invention is not limited thereto and various changes and modifications may be made without departing from the spirit of the invention and the scope of the appended claims.

1. An information recording/reproducing apparatus for recording information to a write-once type information recording medium and reproducing the information recorded to the write-once type information recording medium, comprising:
an area generation unit for generating inside the write-once type recording medium at least a management area for recording file management information for managing a data structure of user data, an audio-video area for recording audio-video information contained in the user data and a non-audio-video area for recording non-audio-video information contained in the user data;
a first splitting unit for closing the management area or the non-audio-video area not capable of recording when a recording capacity of the management area or the non-audio-video area is insufficient and the file management information or the non-audio-video information cannot be recorded additionally, splitting the audio-video area into a recorded area and a non-use area and closing the audio-video area split as the recorded area;
a second splitting unit for splitting the non-use area split by the first splitting unit into a new management area or a new non-audio-video area and a new audio-video area; and
a recording unit for additionally recording the file management information or the non-audio-video information to the new management area or the new non-audio-video area split by the second splitting unit.

2. The information recording/reproducing apparatus according to claim 1, wherein the recording unit additionally records the file management information or the non-audio-video information to the latest management area or the latest non-audio-video area when a plurality of the new management areas or the new non-audio-video areas is generated by the second splitting unit.

3. The information recording/reproducing apparatus according to claim 1, further comprising a backup unit for recording information recorded to the management area to a backup area of the management area, and wherein the backup unit allocates a part of the non-use area of the audio-video area to the backup area when a recording capacity of the backup area is insufficient.

4. An information recording method in an information recording/reproducing apparatus for recording information to a write-once type information recording medium and reproducing the information recorded to the write-once type information recording medium, comprising:
the area generation step of generating inside the write-once type recording medium at least a management area for recording file management information for managing a data structure of user data, an audio-video area for recording audio-video information contained in the user data and a non-audio-video area for recording non-audio-video information contained in the user data;
the first splitting step of closing the management area or the non-audio-video area not capable of recording when a recording capacity of the management area or the non-audio-video area is insufficient and the file management information or the non-audio-video information cannot be recorded additionally, splitting the audio-video area into a recorded area and a non-use area and closing the audio-video area split as the recorded area;
the second splitting step of splitting the non-use area split by the first splitting step into a new management area or a new non-audio-video area and a new audio-video area; and
the recording step of additionally recording the file management information or the non-audio-video information to the new management area or the new non-audio-video area split by the second splitting unit.
